(19) United States
(12) Patent Application Publication
(10) Pub. No.: US 2026/0285730 A1
(43) Pub. Date: Sep. 24, 2026

(54) Modular Water Disinfection System with Integrated UV-C, Ozone, and IoT Monitoring.

(71) Applicant: Chloe Stiewert, Rochester, TX (US)

(72) Inventor: Chloe Stiewert, Rochester, TX (US)

(21) Appl. No.: 19/567,879

(22) Filed: Mar. 16, 2026

Related U.S. Application Data
(60) Provisional application No. 63/774,235, filed on Mar. 19, 2025.

(51) Int. Cl. C02F 9/20; C02F 1/32; C02F 1/78; C02F 101/00; C02F 103/00

(52) U.S. Cl. CPC C02F 9/20; C02F 1/325; C02F 1/78; C02F 2101/00; C02F 2103/007; C02F 2201/007; C02F 2201/009; C02F 2201/3228; C02F 2201/782; C02F 2209/001; C02F 2303/04

(57) ABSTRACT

A modular water disinfection system and method utilizing ultraviolet (UV-C) radiation, ozone oxidation, and IoT-based real-time monitoring for scalable water purification. The system features a buoyant housing with a central flow passage configured for bottom-to-top vertical fluid movement. A venturi throat within the passage facilitates passive ozone induction, while a quartz-encapsulated UV-C unit provides germicidal irradiation. An integrated sensor suite and control logic enable autonomous adjustment of disinfection intensity based on real-time water quality metrics. The system is configured for diverse applications, including the treatment of natural water bodies to eliminate pathogens such as amoebas, and industrial upstream conditioning to reduce chemical demand in downstream municipal utility facilities.

### CROSS-REFERENCE TO RELATED APPLICATIONS

This application claims the benefit of priority to U.S. Provisional Application No. 63/774,235, filed Mar. 19, 2025, which is incorporated herein by reference in its entirety.

### BACKGROUND OF THE INVENTION

Waterborne diseases and contamination are a major global issue. Traditional water treatment methods rely heavily on chemical disinfectants such as chlorine, which can introduce harmful byproducts. Additionally, many existing systems are energy-intensive and lack real-time monitoring. This invention provides a scalable, sustainable, and efficient solution for water disinfection using a modular system integrating UV-C, ozone, and IoT sensors.

### BRIEF SUMMARY OF THE INVENTION

This invention provides a modular water disinfection system that combines UV-C sterilization, ozone disinfection, and IoT-enabled real-time monitoring to achieve efficient, chemical-free water purification. The system is scalable and can be used in municipal, industrial, agricultural, lake water treatment, and emergency relief settings. It incorporates renewable energy sources (solar power) for off-grid operation.

### BRIEF DESCRIPTION OF THE DRAWINGS

FIG. 1 is a perspective view of the modular treatment buoy showing the Renewable Energy System (100), the Buoyant Housing (110), and the Central Flow Passage (120).

FIG. 2 is a cross-sectional view of the internal disinfection core illustrating the Venturi Throat (200), Ozone Injection Port (210), UV-C Quartz Sleeve (220), Control Logic (230), and Sensor Suite (240).

### DETAILED DESCRIPTION OF THE INVENTION

The present invention relates to a modular water disinfection system configured for scalable deployment in various water treatment applications. The system is designed to achieve chemical-free water purification using a combination of ultraviolet germicidal irradiation (UV-C), ozone oxidation, and IoT-based real-time monitoring.

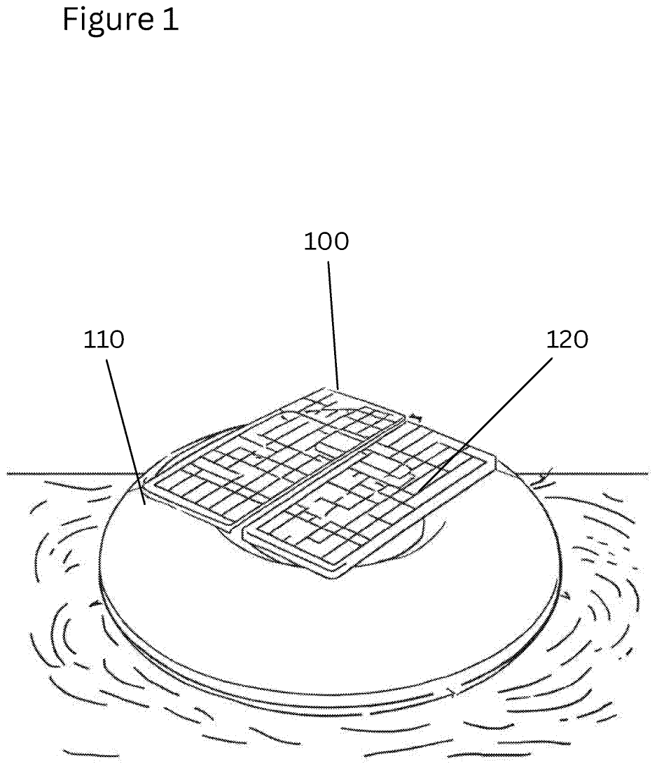

As shown in FIG. 1, the system includes a solar power system 100 mounted to a buoyant housing 110. Water is drawn into the unit through a central flow passage 120, which is configured for vertical fluid movement.

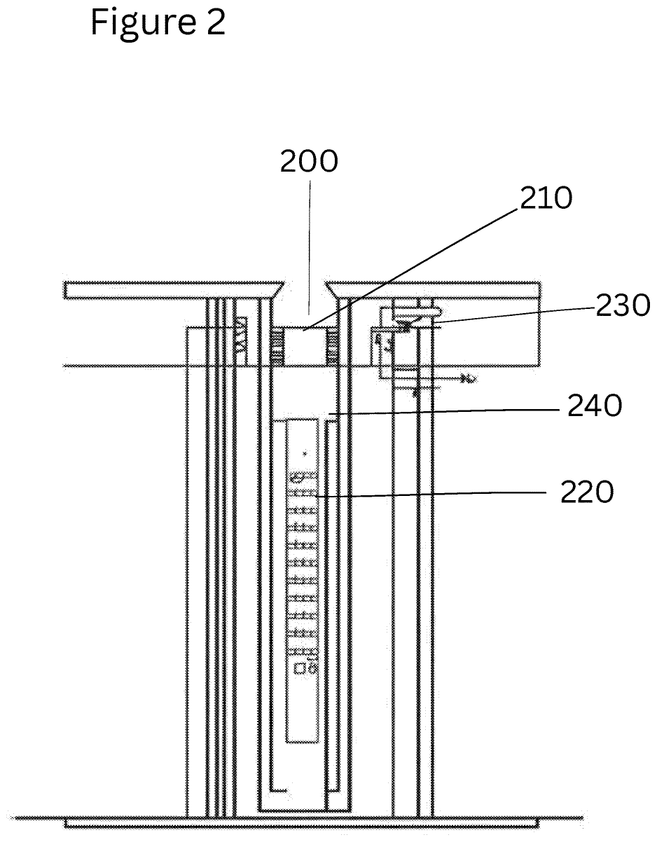

As shown in FIG. 2, the system utilizes a bottom-to-top flow orientation. Water enters the central passage from the bottom of the buoyant housing and rises through a venturi throat 200. This constriction creates a pressure differential that facilitates the passive induction of ozone gas through an ozone injection port 210. The ozone-enriched water stream is then exposed to germicidal radiation via a UV-C quartz sleeve 220, which contains lamps emitting at a primary wavelength of 254 nm. A sensor suite 240 is positioned within the fluid stream to monitor parameters such as pH, turbidity, and microbial content. These metrics are processed by control logic 230, which dynamically modulates the power and intensity of the disinfection components.

### Enhanced Engineering Features

The interior walls of the central flow passage 120 are coated with a UV-reflective material, such as polished aluminum or a specialized fluoropolymer, to maximize germicidal photon density and increase energy efficiency. Additionally, the sensor suite 240 may include ultrasonic transducers configured to generate acoustic cavitation near the UV-C quartz sleeve 220. This prevents the accumulation of mineral scale or biofouling, ensuring the system remains self-cleaning during long-term deployment.

### Advanced Oxidation and Crisis Mitigation

The combination of UV-C and ozone within the passage is configured to facilitate an Advanced Oxidation Process (AOP). By generating hydroxyl radicals, the system is capable of degrading complex chemical contaminants, including PFAS and microplastics. In further embodiments, the system serves as a pre-treatment stage for desalination, reducing biofouling on downstream membranes to extend their operational lifespan.

### Industrial and Upstream Embodiment

In another embodiment, the system is configured as an upstream water conditioning module. The framework is adapted for integration into municipal or industrial influent channels. By utilizing the UV-C and ozone units to neutralize microbial load upstream, the system reduces the chemical demand required by downstream facilities.

1. A modular water disinfection system comprising: a buoyant housing defining a central vertical flow passage; a sensor array for real-time monitoring of water quality; an ozone generation system including a Venturi injector disposed within the flow passage; and a UV-C disinfection unit.

2. The system of claim 1, wherein the UV-C disinfection unit comprises a plurality of UV-C lamps emitting at 254 nm and a quartz sleeve enclosure.

3. The system of claim 1, wherein the central vertical flow passage is configured with a taper to facilitate passive water flow via the Venturi effect.

4. The system of claim 1, further comprising an autonomous control system configured to adjust disinfection intensity based on data from the sensor array with IoT Monitoring.

5. The system of claim 1, wherein the system is configured as an Advanced Oxidation Process (AOP) module capable of generating hydroxyl radicals for the degradation of chemical contaminants.

6. The system of claim 1, further comprising a renewable energy power source (100) enabling off-grid operation.

7. A method of treating natural water bodies to eliminate harmful microorganisms, including amoebas and bacteria, using the system of claim 1.

8. The system of claim 1, wherein the system is configured as an upstream conditioning module to reduce the chemical disinfectant demand of a downstream treatment facility.

9. The system of claim 1, wherein the interior of the central flow passage is coated with a UV-reflective material to enhance germicidal efficiency.

10. The system of claim 1, further comprising an ultrasonic transducer configured to prevent biofouling on the UV-C quartz sleeve.
